(19) United States
(12) Patent Application Publication
(10) Pub. No.: US 2013/0070336 A1
(43) Pub. Date: Mar. 21, 2013

(54) MICROSCOPE APPARATUS HAVING A GOOSENECK OPERATING UNIT

(71) Applicants: Jenni Thomas, Wattwil (CH); Andreas Klopfer, Doren (AT)

(72) Inventors: Jenni Thomas, Wattwil (CH); Andreas Klopfer, Doren (AT)

(73) Assignee: LEICA MICROSYSTEMS (SCHWEIZ) AG, Heerbrugg (CH)

(21) Appl. No.: 13/613,301

(22) Filed: Sep. 13, 2012

(30) Foreign Application Priority Data
Sep. 15, 2011 (DE) 10 2011 082 786.2

(51) Int. Cl. G02B 21/06

(52) U.S. Cl. 359/385

(57) ABSTRACT

A microscope apparatus includes a microscope, a gooseneck holder, and an operating unit configured to control apparatus functions of the microscope apparatus. The operating unit is carried by the gooseneck holder.

### CROSS REFERENCE TO RELATED APPLICATIONS

This application claims priority to German Patent Application No. DE 10 2011 082 786.2, filed Sep. 15, 2011, which is hereby incorporated by reference herein in entirety.

### FIELD

The present invention relates to a microscope apparatus having a gooseneck operating unit and a lighting system.

### BACKGROUND

Microscope apparatuses comprising a microscope and an operating unit for performing apparatus functions of the microscope apparatus are generally known. The apparatus functions include, for example, lighting functions, such as brightness, for example, motorised functions such as movement functions (e.g. magnification, zoom, focussing, movement of a. microscope stage, etc.) and many others. An operating unit may include only operating elements that cooperate with electronic control means or a control circuit elsewhere in the microscope apparatus. However, the electronic control means may also be integrated in the operating unit. The electronic control means operate suitable actuators for triggering the apparatus functions.

DE 102 49 177 A1 describes a microscope apparatus having two operating units, for example, one of which is in the form of a computer mouse while another is embodied as an actual computer. Both are connected to the microscope apparatus by cable connections.

However, known operating units have disadvantages. If they are only loosely attached to the microscope apparatus, for example by means of a. cable, the operating unit takes up additional space on the examination bench and may also be lost in transit or during storage. Operating units of this kind are generally also very bulky in construction so that they do not move accidentally during operation. This further increases the space they take up.

If the operating unit is mounted directly on the microscope apparatus, for example in the stand, its accessibility and operability are restricted. This is particularly true when the operator is left-handed.

With many operating units there is also the problem that they are not positioned within the field of vision of the operator, so that during use the operator has to switch his gaze back and forth constantly between the operating unit and the microscope.

Microscope operation using a computer is complex and in addition to the problems already mentioned it also has the drawback of taking up a great deal of space. The transporting of the microscope apparatus is also made more difficult by the fact that the computer has to be taken along as well.

It is desirable to provide an improved microscope apparatus with operating unit in order to overcome the disadvantages mentioned above. In particular, accessibility should be improved and positioning should be made easier.

### SUMMARY

In an embodiment, the present invention provides a microscope apparatus including a microscope, a gooseneck holder, and an operating unit configured to control apparatus functions of the microscope apparatus. The operating unit is carried by the gooseneck holder.

### BRIEF DESCRIPTION OF THE DRAWINGS

Exemplary embodiments of the present invention are described in more detail below and schematically shown in the drawings, in which:

FIG. 1 shows an embodiment of a microscope apparatus according to the invention in schematic side view; and

FIG. 2 shows an embodiment of a microscope apparatus according to the invention in perspective view.

### DETAILED DESCRIPTION

In an embodiment, the present invention provides a microscope apparatus and a lighting system.

In an embodiment, the present invention provides that an operating unit be attached to the microscope apparatus by means of a gooseneck holder. By the term “gooseneck” (also called “swan neck”) is meant a flexible but dimensionally stable or shape-stable arm. It can he deformed by the application of a minimal force, which is expediently above the gravitational force or weight of the object being carried. Conventionally, a gooseneck often consists of a coiled metal tube. A gooseneck in accordance with embodiments of the invention may be hollow or filled, it may be made of any desired material (for example metal or plastics), it may be helically coiled or have some other structure so long as it is flexible and dimensionally stable (shape stable).

In an embodiment, a microscope apparatus with operating unit is proposed in which the operating unit is fixedly connected to the microscope but can be positioned relatively freely. In particular, it can be arranged particularly easily by the operator in a position that suits them. For example, it may be arranged in its height and position to suit both right- and left-handed people. The fixed connection to the microscope ensures that it cannot be lost. Nor does it take up any room on an examination bench. The operating unit proposed within the scope of the invention may in particular be arranged and also operated one-handed. A number of disadvantages connected with other operating units are overcome.

The operating unit can he used to control apparatus functions of the microscope apparatus as described hereinbefore or in DE 102 49 177 A1 (to which reference is expressly made in this context). In addition to operating elements such as, in particular, sensors, switches, touchpads (the term “touchpad” is used to denote a touch-sensitive surface of the kind provided for example as a replacement for a mouse or keypad in notebooks, generally underneath the keyboard), touchscreens, plastic film keyboards, etc., the operating unit may comprise electronic control means and/or lighting means. The lighting means may be provided for lighting the operating unit, for displaying the apparatus functions that have been initiated and/or operating elements that have been actuated. Alternatively or additionally, lighting means may also be provided as a lighting device for the microscope for illuminating a specimen that is to be studied.

If the electronic control means are separate from the operating unit (for example mounted on the microscope apparatus itself), the operating unit may be more manageable and lightweight in construction and take up less space. In this embodiment the operating unit essentially comprises only the operating elements and the necessary electrical connecting means to the electronic control means. The operating unit is lightweight and manageable, the gooseneck holder does not have to bear much weight and can therefore be of simple design, The electronic control means, that are conventionally large and heavy, may be mounted on the microscope apparatus itself, for example. The electromagnetic compatibility can be improved by a suitable housing for the electronic control means, which does not have to have any openings for the operating elements. The separation of the operating elements and electronic control means is advantageous, in order to enable the operating unit itself to be made small, lightweight and manageable. A compact construction allows a better view of the object under examination and greater ease of operation. The electronic control means, on the other hand, may have a high electrical power consumption and consequently give off a great deal of heat, which can be discharged through a solid carrier housing (e.g. having cooling fins, etc.).

The operative connection between the operating unit and the microscope apparatus (for example between the operating elements and the electronic control means or between the electronic control means and the actuators) may be through cables or it may be wireless. All known types of transmission are suitable for this. A cable connection is preferably guided within a hollow gooseneck holder.

The operating unit may be releasably mounted on the gooseneck holder and/or the gooseneck holder may be releasably mounted on the microscope apparatus. Thus, in addition to the fixed connection, a loose connection may be provided by detaching the operating unit from the microscope apparatus, for example if the operator wishes to place the operating unit somewhere else. Connecting means (such as a plug-in connection, a magnetic connection, a screw connection, etc.) are provided which allow the connection to be undone, and in the connected state provide a mechanical and optionally also an electrical connection.

100211 If the operating unit is releasably mounted on the gooseneck holder a wireless operative connection is preferred, in particular. In this case the operating unit is expediently provided with an energy supply, such as an accumulator or battery. When the operating unit has not been disconnected from the gooseneck holder it is possible to charge a battery, for example.

Further advantages and embodiments of the invention will become apparent from the description and from the attached drawings.

It will be understood that the features mentioned hereinbefore and the features that are yet to be described hereinafter may be used not only in the particular combination stated but also in other combinations or on their own, without departing from the scope of the present invention.

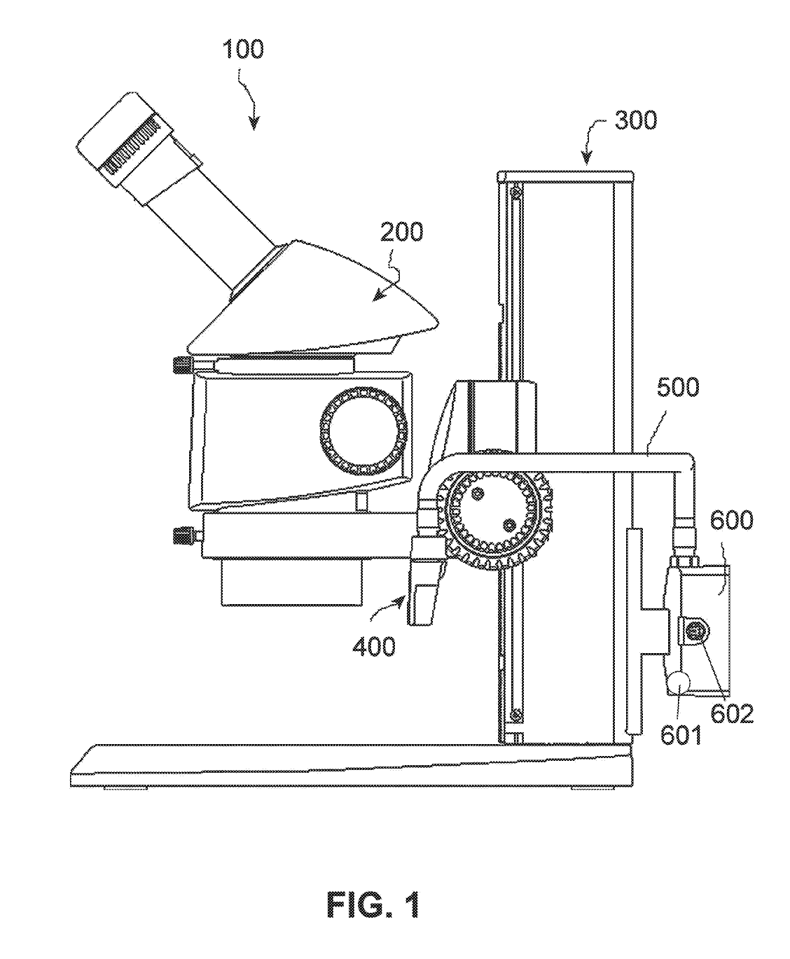

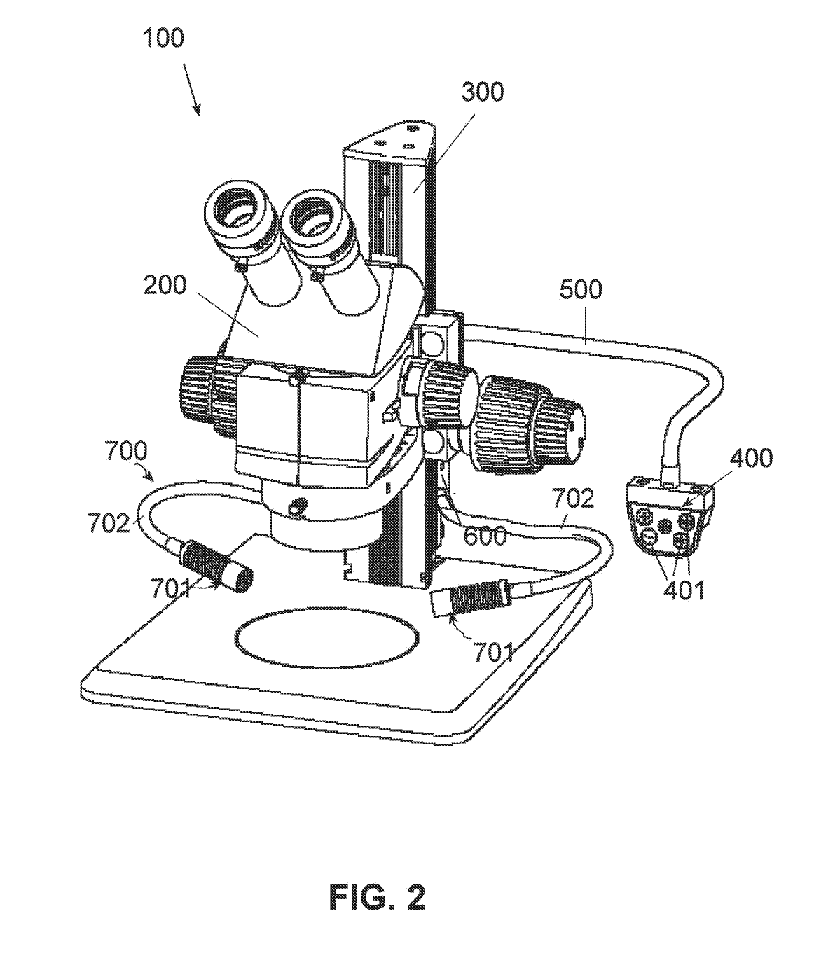

FIGS. 1 and 2 are described cohesively and comprehensively, identical elements being given identical reference numerals. The embodiment according to FIG. 2 differs from the embodiment according to FIG. 1 by an additional lighting device 700.

FIG. 1 shows a preferred embodiment of a. microscope apparatus according to the invention in schematic side view and generally designated 100. The microscope apparatus 100 comprises an optical microscope 200 that is mounted on a stand 300 so as to be vertically movable. The microscope apparatus further comprises an operating unit 400, which is provided for the purpose of controlling apparatus functions of the microscope apparatus. The operating unit 400 is attached to a carrier housing 600 by means of a gooseneck holder 500. The gooseneck holder 500 is embodied as a coiled metal tube. The carrier housing 600 is attached to the stand 300 of the microscope apparatus 100. The attachment may be releasable.

The microscope 200 is an optical microscope which is embodied as a stereomicroscope with a large operating distance. However, in principle, the microscope apparatus may comprise any desired microscope.

In the embodiment shown in FIG. 2, the operating unit is set up to control lighting functions. For this purpose, electronic control means are provided in the carrier housing 600, which actuate a lighting device 700 for lighting an object that is to be examined. On the carrier housing 600 is provided a connection 602, particularly for supplying current to the lighting device and/or the electronic control means. The leads to the connection of the operating unit to the electronic control means expediently run inside the gooseneck holder 500.

The lighting device 700 comprises two light sources 701 which are preferably embodied as LED lamps. Each light source 701 is carried by a lighting arm 702, the two lighting arms 702 also being mounted on the carrier housing 600. The lighting arms 702 also consist of or comprise gooseneck holders so as to connect the light sources 701 mechanically to the carrier housing 600. Cables run inside the gooseneck holders 702 for electrically connecting the light sources 701 to the electronic control means inside the carrier housing 600.

If the lighting arms 702 are releasably mounted on the carrier housing 600, the latter comprises corresponding connecting means on these sides, while FIG. 1 shows a screw-in plug connector 601 by way of example. The gooseneck holder 500 may be connected to the carrier housing 600 in comparable manner. Alternatively or additionally, the embodiment according to FIG. 1 may also comprise a lighting device (not shown) which is integrated in the operating unit 400. This lighting device may serve to illuminate an object that is to be examined,

The operating unit 400 comprises operating elements 401 embodied as touch buttons that serve to control the lighting device 700. Expediently, it is envisaged that the brightness of the light sources 701 should be able to be set jointly or independently of one another, the brightness being adjustable in each case between 0% (i.e. off) and 100% (i.e. full power).

If the operating unit 400 is used to control lighting functions of the lighting device 700, advantageously a lighting system may be provided comprising an operating unit 400, carrier housing 600 and lighting device 700, which can be removed particularly easily by disconnecting the carrier housing 600 from the stand 300. A lighting system of this kind is a further subject of the invention.

Attaching the operating unit 400 to the carrier housing 600 using the gooseneck holder 500 enables it to be positioned relatively freely in space by the operator. In particular, it can be arranged to the right or left of the microscope, so that it is easy for both right- and left--handed people to operate it. In the embodiment shown, the gooseneck holder is attached to the carrier housing 600 on the microscope side and the latter is attached centrally to the stand 300, so that the operating unit can be placed particularly easily both to the right and to the left of the microscope.

The operating unit be arranged so that it can easily be observed from the operator's position at the eyepiece. Expediently the gooseneck holder 500 is long enough to allow the operating unit to be arranged close to a normal hand position for the operator, for example close to the light sources, close to the object being examined or close to the operating wheels for zoom, focus, etc. In particular, the gooseneck holder 500 and the kiting arms 702 as an additional gooseneck holder may be of substantially the same length.

While the invention has been particularly shown and described with reference to preferred embodiments thereof, it will be understood by those skilled in the art that various changes in form and details may be made therein without departing from the spirit and scope of the invention.

What is claimed is:

1: A microscope apparatus comprising:
a microscope;
a gooseneck holder; and
an operating unit configured to control apparatus functions of the microscope apparatus, the operating unit being carried by the gooseneck holder.

2: The microscope apparatus recited in claim 1, wherein the operating unit includes at least one of a touchpad, a touchscreen, a sensor or a switch.

3: The microscope apparatus recited in claim 1, wherein the operating unit includes operating elements that cooperate with electronic controls that are not accommodated in the operating unit.

4: The microscope apparatus recited in claim I, further comprising lighting device, and wherein the operating unit is configured to operate lighting functions.

5: The microscope apparatus recited in claim 4, wherein the lighting device is integrated in the operating unit.

6: The microscope apparatus recited in claim 4, wherein the lighting device includes at least one light source carried by at least one other gooseneck holder.

7: The microscope apparatus recited in claim 6, wherein the gooseneck holder and the at least one other gooseneck holder are attached to a common carrier housing, electronic controls for the lighting device being disposed in the carrier housing.

8: The microscope apparatus recited in claim 7, wherein the carrier housing is releasably attached to the microscope apparatus.

9: The microscope apparatus recited in claim 6, wherein the gooseneck holder and the at least one other gooseneck holder are of substantially the same length.

10: The microscope apparatus recited in claim 6, wherein the at least one other gooseneck holder is releasably attached to the microscope apparatus.

11: The microscope apparatus recited in claim 4, wherein the lighting device includes a plurality of light sources, the operating unit being configured to individually or jointly control a brightness of the plurality of light sources.

12: The microscope apparatus recited in claim 1, wherein an operative connection between the operating unit and the microscope apparatus is wireless.

13: The microscope apparatus recited in claim 1, wherein at least one of the operating unit is releasably attached to the gooseneck holder or the gooseneck holder is releasably attached at a microscope end.

14: The microscope apparatus recited in claim 1, wherein the gooseneck holder includes a. microscope end, and wherein the gooseneck holder is attached centrally with respect to the microscope at the microscope end.

15: The microscope apparatus recited in claim 1, wherein the microscope is an optical stereomicroscope having an operating distance of more than 5 cm.

16: An illuminating system for a microscope comprising:
an operating unit configured to operate lighting functions;
a carrier housing;
a lighting device; and
a gooseneck holder configured to attach the operating unit to the carrier housing.

17: The illuminating system recited in claim 16, wherein the operating unit includes at least one of a touchpad, a touchscreen, a sensor or a switch.

18: The illuminating system recited in claim 16, wherein the operating unit includes operating elements that cooperate with electronic controls disposed in the carrier housing.

19: The illuminating system recited in claim 16, wherein the lighting device includes at least one light source that is attached to the carrier housing by at least one further gooseneck holder.

20: The illuminating system recited in claim 19, wherein the gooseneck holder and the at least one further gooseneck holder are of substantially the same length.

21: The illuminating system recited in claim 19, wherein the at least one further gooseneck holder is releasably attached to the carrier housing.

22: The illuminating system recited in claim 16, wherein the lighting device includes a plurality of light sources, the operating unit being configured to individually or jointly control a brightness of the plurality of light sources.

23: The illuminating system recited in claim 16, wherein at least one of the operating unit is releasably attached to the gooseneck holder or the gooseneck holder is releasably attached at a microscope end.
